(19) United States
(12) Patent Application Publication
(10) Pub. No.: US 2025/0228211 A1
(43) Pub. Date: Jul. 17, 2025

(54) Pet Leash Attachment Apparatus

(71) Applicant: Daniel Bernard Siwy, Cumberland, RI (US)

(72) Inventor: Daniel Bernard Siwy, Cumberland, RI (US)

(21) Appl. No.: 19/022,902

(22) Filed: Jan. 15, 2025

Related U.S. Application Data
(60) Provisional application No. 63/621,060, filed on Jan. 15, 2024.

(51) Int. Cl. A01K 27/00

(52) U.S. Cl. CPC A01K 27/003; A01K 27/005

(57) ABSTRACT

A pet leash attachment apparatus includes an armband and a strap. The armband is adapted to be wrapped around a user's arm. The armband comprises a strap attachment means. The strap has a first end and a second end. The first end is adapted to be releasably attached to the strap attachment mechanism. The second end is adapted to be releasably attached to a handle of a standard pet leash. The strap is non-stretchable, and the second end of the strap is located adjacent to a wrist of the user when the second end of the strap hangs freely.

### FIELD OF THE INVENTION

The present invention relates generally to pet leash accessories. More specifically, the present invention is a pet leash attachment apparatus that attaches a standard pet leash to a user's arm. However, the present invention is not limited to this option, and it may further be adapted for different purposes.

### BACKGROUND OF THE INVENTION

A pet leash is a fundamental tool for pet owners, serving various purposes in the care and control of their pets. Constructed from materials like nylon or leather, the leash typically consists of a length of material with a handle at one end and a clip at the other, designed to attach to the dog's collar or harness. The handle allows the owner to maintain a secure grip, while the clip ensures a reliable connection to the dog. Leashes come in different lengths, with standard options ranging from 4 to 8 feet, catering to various activities and preferences. Additionally, there are specialized leashes such as retractable ones for adjustable length, hands-free leashes for active lifestyles, and training leashes for specific exercises. Reflective features enhance visibility during low-light conditions, and for owners with multiple dogs, multi-dog leashes provide a convenient solution. Ultimately, a dog leash is an indispensable accessory that promotes responsible pet ownership, offering control, safety, and an enjoyable experience during walks, training sessions, and outdoor activities.

It is an objective of the present invention to provide a leash attachment apparatus that prevents pet (e.g., dogs) from escaping a standard pet leash while protecting the user from potential injuries caused by excessive pulling.

### SUMMARY OF THE INVENTION

The present invention discloses a pet leash attachment apparatus. It comprises an armband and a strap. The armband is adapted to be wrapped around a user's arm. The armband comprises a strap attachment means. The strap has a first end and a second end. The first end is adapted to be releasably attached to the strap attachment mechanism. The second end is adapted to be releasably attached to a handle of a standard pet leash. The strap is non-stretchable, and the second end of the strap is located adjacent to a wrist of the user when the second end of the strap hangs freely.

In one embodiment, the armband further comprises an armband adjustment mechanism that allows the user to adjust a circumference of the armband.

In one embodiment, the armband further comprises an inner cushion pad.

In one embodiment, the strap attachment mechanism comprises a D-ring.

In one embodiment, the armband is made from flexible nylon material.

In one embodiment, the first end of the strap is attached to the strap attachment mechanism via a first releasable connector.

In one embodiment, the first releasable connector comprises a carabiner.

In one embodiment, the second end of the strap is attached to the handle of the standard pet leash via a second releasable connector.

In one embodiment, the second releasable connector comprises a carabiner.

In one embodiment, the strap is made from nylon webbing material.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of the present invention.

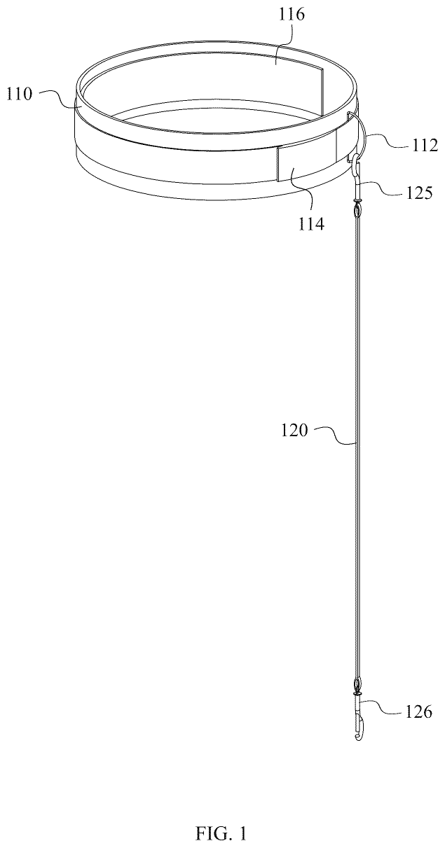

FIG. 2 depicts another perspective view of the present invention.

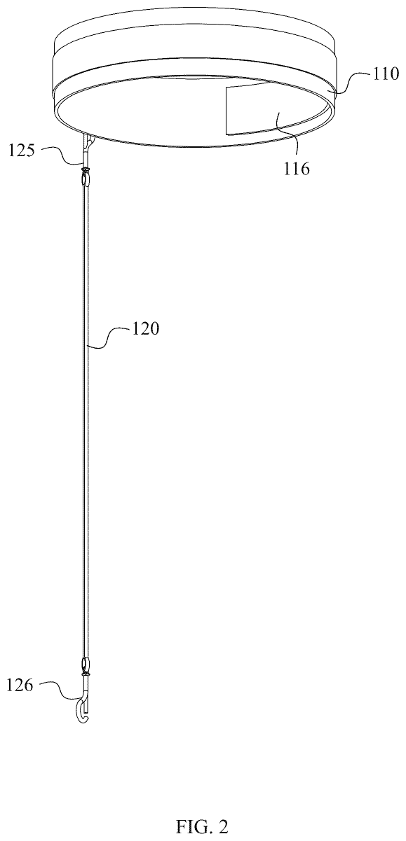

FIG. 3 depicts a top view of the present invention.

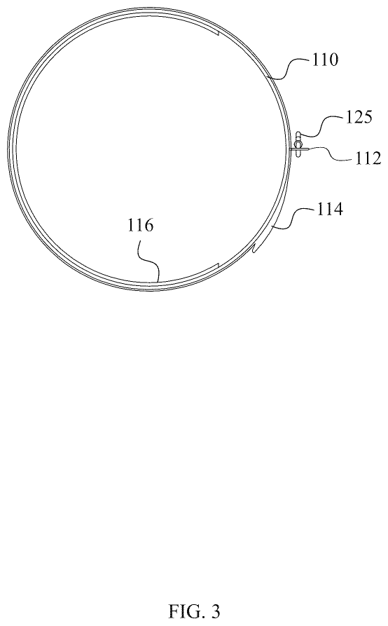

FIG. 4 depicts a front view of the present invention.

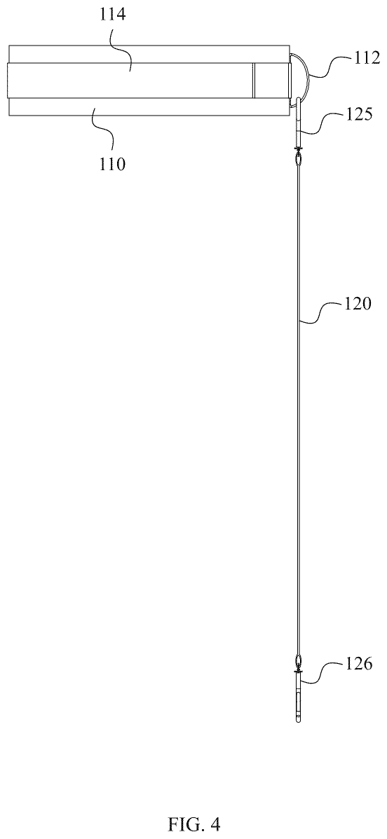

FIG. 5 depicts a right-side view of the present invention.

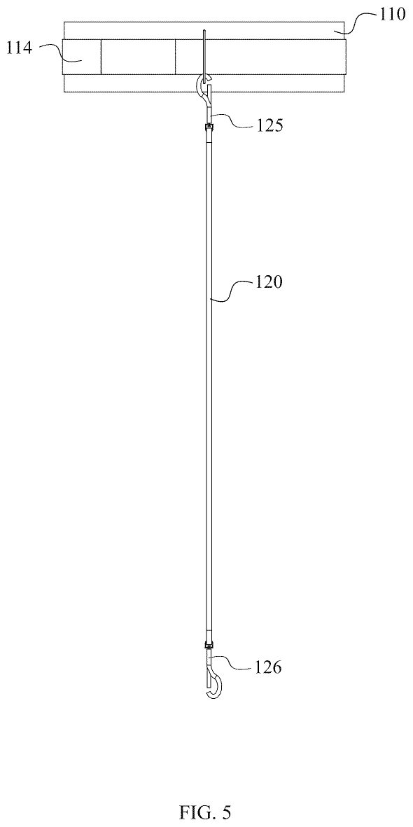

FIG. 6 depicts a perspective view of the strap of the present invention.

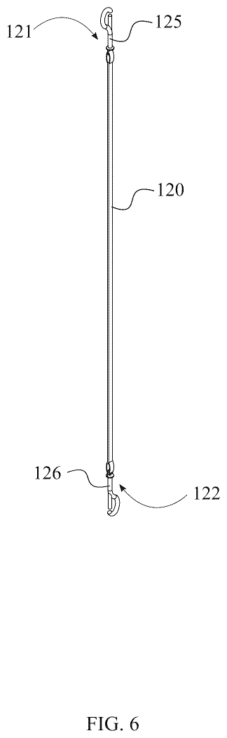

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of pet leash attachment apparatuses, embodiments of the present disclosure are not limited to use only in this context.

The present invention is a pet et leash attachment apparatus that prevents pets (e.g., dogs, etc.) from breaking away from a standard leash. It is an aim of the present invention to provide users with an apparatus that securely attaches to the arm of the user and to the standard dog leash to provide a backup securing mechanism. It is another aim of the present invention to provide an apparatus that allows users to quickly regain control of their pets in the event they lose grip on the standard pet leash.

Referring now to the figures of the present disclosure. The pet leash attachment apparatus of the present invention comprises an armband 110 and a strap 120.

The armband 110 is adapted to be wrapped around a user's arm. It should be noted that the armband 110 can be of any shape, size, material, features, type or kind, orientation, location, quantity, components, and arrangements of components that would allow the present invention to fulfill the objectives and intents of the present invention. In one embodiment, the armband 110 is made from flexible nylon material. Preferably, the armband 110 has a rectangular shape that can wrap around the arm of a user to create a circular or round closed shape. The armband 110 comprises a strap attachment mechanism that allows the strap to attach thereon. In one embodiment, the armband 110 further comprises an armband adjustment mechanism 114 that allows the user to adjust a circumference of the armband 110. In one embodiment, the armband adjustment mechanism 114 comprises hook and loop fasteners. However, it should be noted that any suitable fastening mechanism may be used, such as but not limited to button/buttonholes, snap buttons, etc. In a preferred embodiment, the armband further comprises an inner cushion pad 116. The inner cushion pad 116 is affixed to the inner side of the armband 110 to enhance comfort and reduce the risk of injury during use. In one embodiment, the strap attachment mechanism 112 comprises a D-ring to couple the strap 120 to the armband 110.

The strap 120 attaches to the armband 110 via the strap attachment mechanism 112. It should be noted that the strap 120 can be of any shape, size, material, features, type or kind, orientation, location, quantity, components, and arrangements of components that would allow the present invention to fulfill the objectives and intents of the present invention. The strap 120 has a first end 121 and a second end 122. The first end 121 is adapted to be releasably attached to the strap attachment mechanism 112, and the second end 122 is adapted to be releasably attached to a handle of a standard pet leash. The strap 120 is non-stretchable. Preferably, the strap 120 may be made from nylon webbing material that can easily flex and bend in shape but cannot stretch. When the second end 122 of the strap 120 hangs freely, the second end 122 of the strap 120 is located adjacent to the wrist of the user. In other words, the length of the strap allows the user to regain control of the handle of the standard pet leash if the user loses control of the hand of the standard pet leash. Such situations might occur if a dog pulls forcefully on the leash or if the handle unintentionally slips from the user's hand. Moreover, if the user loses grip on the handle of the standard pet leash, the leash remains securely connected to the armband, preventing the pet from escaping. The armband 110 in this invention is designed to wrap around the user's arm, particularly the upper arm. Unlike similar devices that attach around the waist, this configuration significantly reduces the risk of injury in the event of a sudden pull or breakaway. The present invention provides a strong sense of security due to the stable arm connection and the ease of regaining control of the leash.

In one embodiment, the first end 121 of the strap 120 is attached to the strap attachment mechanism 112 via a first releasable connector 125. In a preferred embodiment, the first releasable connector 125 comprises a carabiner. In one embedment, the second end 122 of the strap 120 is attached to the handle of the standard pet leash via a second releasable connector 126. In a preferred embodiment, the second releasable connector 126 comprises a carabiner. It should be noted that other types of connectors may also be used. The first releasable connector 125 and the second releasable connector 126 may also include rotating eyelets, allowing for rotational movement of the connectors. The rotating eyelet ensures the connectors can rotate 360 degrees. This design ensures that the strap 120 does not tangle up as the attached pet moves in various directions.

It is envisioned that the sizes of the components forming the present invention such as the armband 110 and/or the strap 120 can vary based on design requirements.

Although the disclosure has been explained in relation to its preferred embodiment, it is to be understood that many other possible modifications and variations can be made without departing from the spirit and scope of the disclosure.

What is claimed is:

1. A pet leash attachment apparatus comprising:
an armband adapted to be wrapped around a user's arm, the armband comprising a strap attachment means;
a strap having a first end and a second end, the first end being adapted to be releasably attached to the strap attachment mechanism, the second end being adapted to be releasably attached to a handle of a standard pet leash;
wherein the strap is non-stretchable, and the second end of the strap is located adjacent to a wrist of the user when the second end of the strap hangs freely.

2. The pet leash attachment apparatus as claimed in claim 1, wherein the armband further comprises an armband adjustment mechanism that allows the user to adjust a circumference of the armband.

3. The pet leash attachment apparatus as claimed in claim 1, wherein the armband further comprises an inner cushion pad.

4. The pet leash attachment apparatus as claimed in claim 1, wherein the strap attachment mechanism comprises a D-ring.

5. The pet leash attachment apparatus as claimed in claim 1, wherein the armband is made from flexible nylon material.

6. The pet leash attachment apparatus as claimed in claim 1, wherein the first end of the strap is attached to the strap attachment mechanism via a first releasable connector.

7. The pet leash attachment apparatus as claimed in claim 6, wherein the first releasable connector comprises a carabiner.

8. The pet leash attachment apparatus as claimed in claim 1, wherein the second end of the strap is attached to the handle of the standard pet leash via a second releasable connector.

9. The pet leash attachment apparatus as claimed in claim 8, wherein the second releasable connector comprises a carabiner.

10. The pet leash attachment apparatus as claimed in claim 1, wherein the strap is made from nylon webbing material.
